(19) United States
(12) Patent Application Publication
(10) Pub. No.: US 2014/0184392 A1
(43) Pub. Date: Jul. 3, 2014

(54) RFID tag method and apparatus encoded with protective equipment information

(71) Applicant: Jason Weiss, Katy, TX (US)

(72) Inventor: Jason Weiss, Katy, TX (US)

(21) Appl. No.: 13/694,753

(22) Filed: Dec. 31, 2012

(51) Int. Cl. G06K 7/01; G06K 19/07

(52) U.S. Cl. CPC G06K 7/01; G06K 19/0723
USPC 340/10.51; 235/492

(57) ABSTRACT

A method and apparatus for encoding RFID tags includes the steps of encoding a first set of the RFID tag device bit positions with bits having a one-to-one correspondence with elements of a set of types of protective equipment, encoding a second set of the RFID tag device bit positions with bits having a one-to-one correspondence with elements of a set of types of hazardous environments, communicating the status of bit settings of the first set of bit positions and bit settings of the second set of bit positions to a person, such that the person becomes aware of the requirement for appropriate protective equipment with respect to specific hazardous environments.

### CROSS-REFERENCE TO RELATED APPLICATION

This application claims priority based upon my co-pending Provisional Application Ser. No. 61/582,896, filed Jan. 4, 2012.

### BACKGROUND OF THE INVENTION

1. Field of the Invention

The present invention relates generally to RFID tag devices, and, more particularly, to RFID tag devices especially adapted for informing a worker with information about the personal protective equipment required to ensure the safety and health of the worker in potentially hazardous workplace environments.

2. Description of the Prior Art

Throughout the years, a number of innovations have been developed relating to RFID tag devices. Very often, RFID tag devices are used in retail environments to code retail items with identification information.

There are environments vastly different from a retail environment, and such environments include hazardous environments wherein workers employ protective equipment for their safety and health. Employment of such protective equipment is often required for compliance with governmental rules or regulations.

Currently, the primary means of ensuring working safety today is through the use of classroom education and posted placards. These passive methods fail to remind the worker that ultimately they are responsible for their own safety. Worse, these passive methods cannot capture worker compliance.

When workers and their employers rely solely on placards and other physical warnings, such physical warnings offer no interactive process either of verifying that the warning has been given or that the worker is acting in compliance with that warning. In this respect, to assure that supervisory personnel are aware of worker compliance with workplace warnings, it would be desirable if an interactive process were provided either of verifying that the warning has been given or that the worker is acting incompliance with that warning.

It is well known that workers in hazardous environments, for example factories and warehouses, may inadvertently overlook posted warnings and thus expose themselves to danger when working in the hazardous environments. However, simple and inexpensive devices are not disclosed in the prior art to proactively remind the workers of the posted warnings relating to exposure to danger when working in the hazardous environments. In this respect, as a simple and inexpensive solution to these problems, it would be desirable to employ RFID tag devices to remind the workers of the posted warnings relating to exposure to danger and to capture information about their compliance with respect to employing protective equipment for reducing their exposure to danger.

There are many different types of hazardous environments, and, correspondingly, there are different sets of protective equipment to be employed for each hazardous environment. In this respect, it would be desirable if a single RFID tag device were provided that is adapted to be employed with respect to different types of hazardous environments and that is adapted to capture information about a worker's compliance with respect to employing designated protective equipment for reducing their exposure to dangers in those different environments.

Generally, RFID tag devices interact with some sort of external energetic stimulation. One type of external stimulation is a near-field communications-enabled device. In this respect, it would be desirable if each type of near-field communications-enabled device were encoded with specific code for a specific type of protective equipment. In this respect, it would be desirable if such specifically encoded near-field communications-enabled device for specific protective equipment would present the user with a series of placards and acknowledgment screens for the worker to affirm he is wearing the correct protective equipment before entering the hazardous environment.

In addition, to the desired goals of the safety and health of workers in hazardous environments, there are the goals of reduction of workplace-related accidents, fewer worker injury claims, lower safety-related costs to the employer, reduced insurance costs, fewer workers' compensation claims, and proof of compliance wherever documentation is needed. More specifically, in this respect, it would be desirable to be able to provide proof of compliance if documentation is needed.

Thus, while the foregoing discussion of prior art indicates it to be well known to use RFID tag devices, the prior art described above does not teach or suggest a RFID tag method and apparatus encoded with protective equipment information which has the following combination of desirable features: (1) employs RFID tag devices to remind the workers of the posted warnings relating to exposure to danger and to capture information about their compliance with respect to employing protective equipment for reducing their exposure to danger; (2) provides a single RFID tag device that is adapted to be employed with respect to different types of hazardous environments and that is adapted to capture information about a worker's compliance with respect to employing designated protective equipment for reducing their exposure to dangers in those different environments; (3) provides each type of near-field communications-enabled device to be encoded with specific code for a specific type of protective equipment; (4) provides that specifically encoded near-field communications-enabled devices for specific protective equipment would present the user with a series of placards and acknowledgment screens for the worker to affirm he is wearing the correct protective equipment before entering the hazardous environment; (5) provides an interactive process either of verifying that the warning has been given or that the worker is acting in compliance with that warning; and (6) is able to provide proof of compliance if documentation is needed.

The foregoing desired characteristics are provided by the unique RFID tag method and apparatus encoded with protective equipment information of the present invention as will be made apparent from the following description thereof. Other advantages of the present invention over the prior art also will be rendered evident.

### SUMMARY OF THE INVENTION

To achieve the foregoing and other advantages, the present invention, briefly described, provides method for encoding RFID tag devices includes the steps of encoding a first set of the RFID tag device bit positions with bits has a one-to-one correspondence with elements of a set of types of protective equipment, encoding a second set of the RFID tag device bit positions with bits has a one-to-one correspondence with elements of a set of types of hazardous environments, communicating the status of bit settings of the first set of bit positions and bit settings of the second set of bit positions to a person, such that the person becomes aware of the presence of appropriate protective equipment with respect to specific hazardous environments. The communications can be provided to either the worker or the supervisor or both. The communications can be recorded to provide documentation.

The method can include the further step of employing a computer software program operating on a NFC-enabled device for communicating the status of bit settings of the first set of bit positions and bit settings of the second set of bit positions.

The method can include the further steps of employing a computer software program operating on a NFC-enabled device for prompting the worker to take a picture or video of themselves using a built-in camera on the device, storing the picture on the NFC-enabled device's memory card until it is downloaded at a later time, wherein a timestamp of the picture serves as proof that the employee was properly outfitted prior to entering a work area.

The method wherein either the first bit positions or the second bit locations can be related to the serial number of the RFID tag device.

The method wherein either the first bit positions or the second bit positions can be related to a one-time-programmable memory address.

The method wherein a single RFID tag device is encoded with the first set bit positions and the second set of bit positions and provides bit settings for the first set of bit positions and bit settings for the second set of bit positions.

The method wherein a first RFID tag device is encoded with the first set of bit positions and provides bit settings for the first set of bit positions, and a second RFID tag device is encoded with the second set of bit positions and provides bit settings for the second set of bit positions.

The method wherein the first RFID tag device is a near-field communications-enabled device.

The method wherein the first set of bit positions with bits has a one-to-one correspondence with elements of a set of types of protective equipment includes bit positions for protective equipment includes hard hat, ear protection, eye protection, reflective vest, steel toed boots, and leather gloves.

The method wherein the second set of bit positions has a one-to-one correspondence with elements of a set of types of hazardous environments includes bit positions for hazardous environments includes high voltage, no smoking, wet floor, electrostatic devices, inflammable, laser radiation, biological, chemical, and nuclear.

In accordance with another aspect of the invention, an RFID tag apparatus is provided which includes a first set of bits which has a one-to-one correspondence with elements of a set of types of protective equipment.

With the apparatus, the first set of bits are located on a near-field communications-enabled device.

With the apparatus, the RFID tag apparatus includes a second set of bits which has a one-to-one correspondence with elements of a set of types of hazardous environments.

With the apparatus, an RFID tag apparatus includes a second set of bits which has a one-to-one correspondence with elements of a set of types of hazardous environments.

Workers in hazardous environments, for example factories and warehouses, may inadvertently overlook posted warnings and thus expose themselves to danger. This invention proactively reminds the workers of the warnings and captures their compliance.

If the worker uses the invention as it has been designed, the worker should not be able to disregard hazardous environment warnings without a supervisor's knowledge. Businesses in virtually any field can use the invention to track their workers' safety compliance.

Benefits are the reduction of workplace-related accidents, fewer worker injury claims, lower safety-related costs to the employer, reduced insurance costs, fewer workers' compensation claims, and proof of compliance wherever documentation is needed.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved RFID tag method and apparatus encoded with protective equipment information which has all of the advantages of the prior art and none of the disadvantages.

It is another object of the present invention to provide a new and improved RFID tag method and apparatus encoded with protective equipment information which may be easily and efficiently manufactured and marketed.

It is a further object of the present invention to provide a new and improved RFID tag method and apparatus encoded with protective equipment information which is of durable and reliable construction.

An even further object of the present invention is to provide a new and improved RFID tag method and apparatus encoded with protective equipment information which is susceptible of a low cost of manufacture with regard to both materials and labor, and which accordingly is then susceptible of low prices of sale to the consuming public, thereby making such RFID tag method and apparatus encoded with protective equipment information available to the buying public.

Still yet a further object of the present invention is to provide a new and improved RFID tag method and apparatus encoded with protective equipment information which employs RFID tag devices to remind the workers of the posted warnings relating to exposure to danger and to capture information about their compliance with respect to employing protective equipment for reducing their exposure to danger.

Still another object of the present invention is to provide a new and improved RFID tag method and apparatus encoded with protective equipment information that provides a single RFID tag device that is adapted to be employed with respect to different types of hazardous environments and that is adapted to capture information about a worker's compliance with respect to employing designated protective equipment for reducing their exposure to dangers in those different environments.

Yet another object of the present invention is to provide a new and improved RFID tag method and apparatus encoded with protective equipment information which provides each type of near-field communications-enabled device to be encoded with specific code for a specific type of protective equipment.

Even another object of the present invention is to provide a new and improved RFID tag method and apparatus encoded with protective equipment information that provides specifically encoded near-field communications-enabled devices for specific protective equipment to present the user with a series of placards and acknowledgment screens for the worker to affirm he is wearing the correct protective equipment before entering a hazardous environment.

Still a further object of the present invention is to provide a new and improved RFID tag method and apparatus encoded with protective equipment information which provides an interactive process either of verifying that the warning has been given or that the worker is acting in compliance with that warning.

Yet another object of the present invention is to provide a new and improved RFID tag method and apparatus encoded with protective equipment information that is able to provide proof of compliance if documentation is needed.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is an illustration of the assignment of protective equipment to bit positions on the RFID tag device.

FIG. 2 is an illustration of the assignment of a protective equipment set based on the serial number of the RFID tag device.

FIG. 3 is an illustration of the assignment of a protective equipment set based on an integer key in the RFID one-time-programmable (OTP) memory.

FIGS. 4 and 5 are borrowed from the UPM/NXP NTAG203 specification sheet of the RFID tag device. More specifically, in FIG. 4, RFID tag device 144 generally is rectangular in shape and has a length dimension A and a width dimension B.

FIG. 5 schematically depicts the various structural parts of the RFID tag device 144 package.

### DESCRIPTION OF THE PREFERRED EMBODIMENT

With reference to the drawings, a new and improved RFID tag method and apparatus encoded with protective equipment information embodying the principles and concepts of the present invention will be described.

As an introductory remark, it is well known that Near Field Communication (NFC) is a set of standards for smartphones and similar devices to establish radio communication with each other by touching them together or bringing them into close proximity, usually no more than a few centimeters. Present and anticipated applications include contactless transactions, data exchange, and simplified setup of more complex communications such as Wi-Fi. Communication is also possible between an NFC device and an unpowered NFC chip, called a “tag”.

NFC standards cover communications protocols and data exchange formats, and are based on existing radio-frequency identification (RFID) standards including ISO/IEC 14443 and FeliCa. The standards include ISO/IEC 18092 and those defined by the NFC Forum, which was founded in 2004 by Nokia, Philips and Sony, and now has more than 160 members. The Forum also promotes NFC and certifies device compliance.

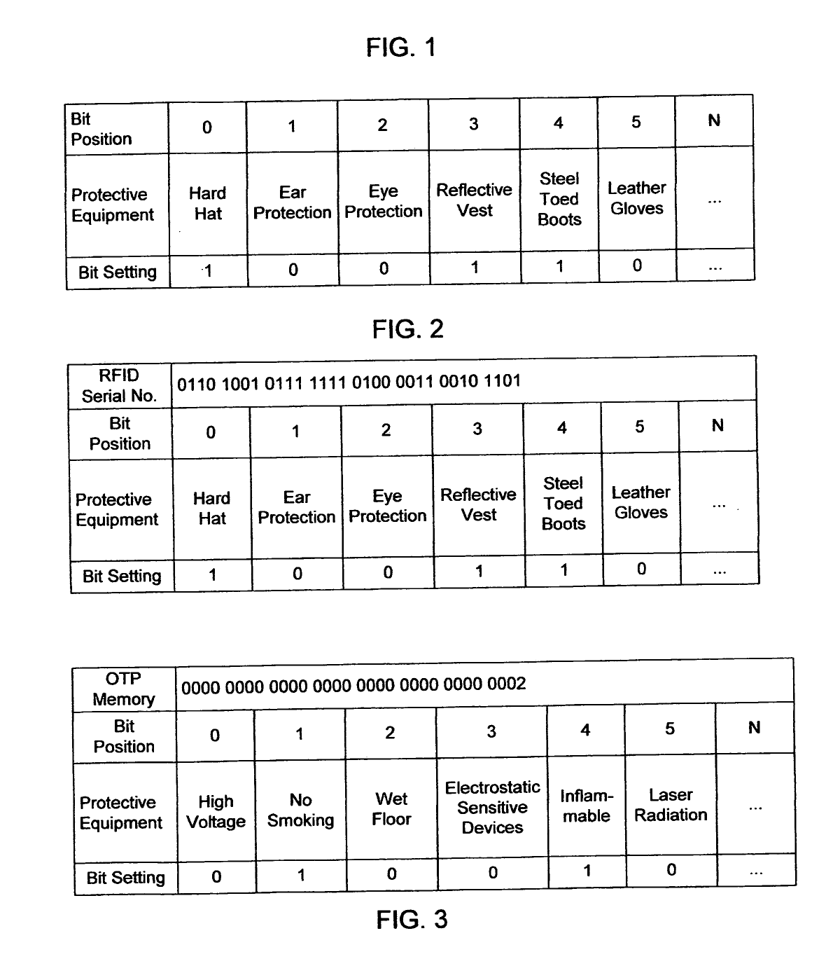

Turning to the subject invention, generally, the invention is comprised of a RFID tag device whereon a series of integer bit position values are written into the tag's read/write memory as shown in FIG. 1. In FIG. 1, bit coding is provided for a set of different types of protective equipment. In FIG. 1, bit coding for each specific hazardous environment is not listed. See FIG. 3 for bit coding of hazardous environments.

In carrying out the invention, computer code is embedded in the RFID tag, and the corresponding code is in an application aboard an NFC-enabled device (e. g. a near-field communications-enabled device).

In addition, the invention employs a computer software program operating on a NFC-enabled device (e. g. a near-field communications-enabled device) and intended to communicate with RFID tags.

The software on the NFC-enabled device communicates with the RFID tag. The software then notifies the workplace supervisor of certain conditions if preprogrammed parameters are met.

One unique feature of this invention is that it represents an active method of reminding the worker of their safety obligations, capturing their acknowledgement that they are entering the work area with proper safety equipment. Another unique feature of this invention is that it provides proof of corporate and statutory safety compliance prior to entering the work area through the multimedia capabilities of the NFC-enabled device.

Should an accident occur, the invention can reduce or mitigate claims of negligence since there is concrete proof that the worker entered the work area with all the requisite safety equipment. This invention also provides the unique ability of tracking either, a count or chronological duration of specific pieces of safety equipment within a work area. In the event that safety equipment is only rated for a fixed number of applications or limited to a maximum amount of time in a work area, the system can track these statistics in an automated fashion and advise the employee that they should not enter the work area if their equipment has expired or is scheduled to expire during their work period.

In addition, the NFC device's multimedia capabilities capture a snapshot or video of the worker properly outfitted with the protection equipment. Where the work area is protected by a remotely controlled lock, the RFID tag can be used as part of the lock out procedure for the space. Workers can enter the work area only after affirming compliance with all safety regulations.

The NFC-enabled device can be connected to the Internet. The RFID serial number and/or one-time programmable memory can be used to query dynamically worker compliance with protective equipment requirements. In addition to displaying industry standard safety placards, custom placards designed by the company itself could be included in this process.

It is noted at the outset that a single RFID tag device can be encoded for both a set of different types of protective equipment and a set of different hazardous environments. Alternatively, with the subject invention, two types of RFID tag devices can be employed. A first RFID tag device can be used for a set of different types of protective equipment, and a set of second RFID tag devices can be employed for a set of respective different types of protective equipment.

As an alternative to a set of second RFID tag devices, a set of near-field communications-enabled devices can be employed.

In FIG. 1, a set of bit positions are shown, and a corresponding set of types of protective equipment are shown as Protective Equipment. Such protective equipment include hard hat (bit position 0), ear protection (bit position 1), eye protection (bit position 2), reflective vest (bit position 3), steel toed boots (bit position 4), and leather gloves (bit position 5), among others, not listed, (up to bit positions N).

In FIG. 1, Bit Position 0, corresponding to hard hat is set as Bit Setting 1, meaning that a hard hat is employed. Bit Position 1, corresponding to ear protection is set as Bit Setting 0, meaning that ear protection is not employed. Bit Position 2, corresponding to eye protection is set as Bit Setting 0, meaning that eye protection is not employed. Bit Position 3, corresponding to reflective vest is set as Bit Setting 1, meaning that a reflective vest is employed. Bit Position 4, corresponding to steel toed boots is set as Bit Setting 1, meaning that steel toed boots are employed. Bit Position 5, corresponding to leather gloves is set as Bit Setting 0, meaning that leather gloves are not employed.

In FIG. 2, WA 32-bit integer has 32 different flags that can be mapped to various pieces of protective equipment, as depicted in FIGS. 1 and 2. A specific 32 bit serial number for a RFID tag device is disclosed as 0110 1001 0111 1111 0100 0011 0010 1101. An NFC-enabled device is either preconfigured with images of the safety equipment or relies on an Internet connection to obtain pictures of the safety equipment. The NFC-enabled device reads the data from the RFID tag using well known means. The serial number, shown in FIG. 2 or one-time programmable memory address (OTP memory), shown in FIG. 3, are also read from the RFID tag.

The NFC-enabled device then uses the serial number or one-time programmable memory entry to lookup the map that relates the read/write memory bits to various pieces of protective equipment. For each bit that is set to 1 (true), a picture of the protective equipment is presented to the user along with click-through acknowledgment text. When the worker clicks through the acknowledgement, they are certifying that they are wearing that safety equipment. If the NFC-enabled device is configured using simple name-value key pairs, the software on the NFC-enabled device may prompt the worker to take a picture or video of themselves using the built-in camera on the device. The picture is then stored on the NFC-enabled device's memory card until it is downloaded at a later time. The timestamp of the picture serves as proof that the employee was properly outfitted prior to entering the work area.

In FIG. 2, Bit Position 0, corresponding to hard hat is set as Bit Setting 1, meaning that a hard hat is employed. Bit Position 1, corresponding to ear protection is set as Bit Setting 0, meaning that ear protection is not employed. Bit Position 2, corresponding to eye protection is set as Bit Setting 0, meaning that eye protection is not employed. Bit Position 3, corresponding to reflective vest is set as Bit Setting 1, meaning that a reflective vest is employed. Bit Position 4, corresponding to steel toed boots is set as Bit Setting 1, meaning that steel toed boots are employed. Bit Position 5, corresponding to leather gloves is set as Bit Setting 0, meaning that leather gloves are not employed.

In FIG. 3, 32 bits of OTP memory can be coded to respective 32 bit positions that correspond to different specific hazardous environments. A specific 32 bit address of OTP memory is disclosed as 0000 0000 0000 0000 0000 0000 0000 0002.

In FIG. 3, each Bit Position can relate to a specific hazardous environment. Among possible hazardous environments are high voltage (bit position 0), no smoking (bit position 1), wet floor (bit position 2), electrostatic devices (bit position 3), inflammable (bit position 4), and laser radiation (bit position 5), among others not specified in FIG. 3, such as biological, chemical, and nuclear among still others.

In FIG. 3, Bit Position 0, corresponding to a high voltage environment is set as Bit Setting 0, meaning that a high voltage environment is not employed. Bit Position 1, corresponding to a no smoking environment is set as Bit Setting 1, meaning that a no smoking environment is employed. Bit Position 2, corresponding to a wet floor environment is set as Bit Setting 0, meaning that a wet floor environment is not employed. Bit Position 3, corresponding to an electrostatic sensitive devices embodiment of the invention is set as Bit Setting 0, meaning that an electrostatic sensitive devices environment is not employed. Bit Position 4, corresponding to an inflammable environment is set as Bit Setting 1, meaning that an inflammable environment is employed. Bit Position 5, corresponding to a laser radiation environment is set as Bit Setting 0, meaning that a laser radiation environment is not employed.

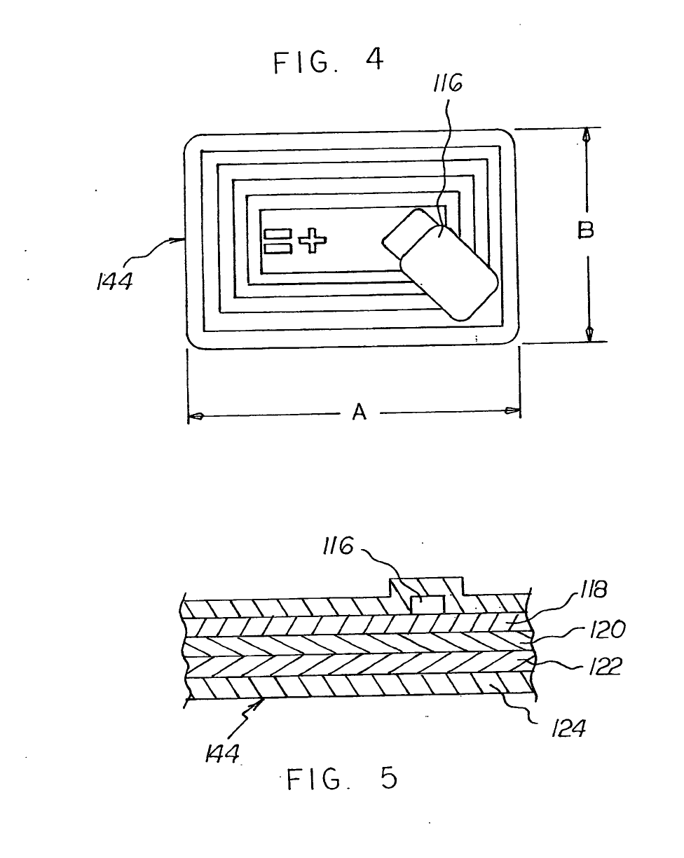

RFID tags are widely commercially available with the RFID tag (or label) distributed by UPM RFID under stock code: NXP NTAG203 being mostly preferred in carrying out the present invention. The mostly preferred RFID tag device is denoted by reference sign 144 and is depicted schematically in FIGS. 4 and 5 which figures are borrowed from the UPM/NXP NTAG203 specification sheet.

More specifically, as shown in FIG. 4, RFID tag device 144 generally is rectangular in shape and has a length dimension A and a width dimension B. To give an idea of the miniature size or scale of the tag: dimension A is about 19 mm whereas dimension B is about 9 mm, and the overall thickness of the tag package is about 162 μm.

FIG. 5 schematically depicts the various structural parts of the RFID tag device 144 package. As shown therein an integrated circuit 116 is placed over antenna 118 and covered by a suitable protective face material 118. The integrated circuit and antenna are supported by a substrate (PET) 120 which in turn has a penultimate layer of adhesive 122 on its underside protected by a bottom layer of release paper 124. Conveniently, RFID tag devices 144 are contained on a roll of such release paper 124 containing multiple tags or units 144, each with its own memorized unique electronic identification signal or fingerprint. Each unit, or separate tag, may be peeled off the roll serially, then attached respectively to a discrete article by means of adhesive layer 122. In this manner, it may be seen that an individual RFID tag device 144 easily may be attached to a type of protective apparatus contemplated by the present invention. And when this is done, in accordance with the invention, each type of protective apparatus so constructed bears a discrete readable electronic code or fingerprint uniquely associated with that particular type of protective apparatus.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved RFID tag method and apparatus encoded with protective equipment information that is low in cost, relatively simple in design and operation. With the invention, a RFID tag method and apparatus encoded with protective equipment information is provided which employs RFID tag devices to remind workers of the posted warnings relating to exposure to danger and to capture information about their compliance with respect to employing protective equipment for reducing their exposure to danger. With the invention, a RFID tag method and apparatus encoded with protective equipment information provides a single RFID tag device that is adapted to be employed with respect to different types of hazardous environments and that is adapted to capture information about a worker's compliance with respect to employing designated protective equipment for reducing their exposure to dangers in those different environments. With the invention, a RFID tag method and apparatus encoded with protective equipment information provides each type of near-field communications-enabled device to be encoded with specific code for a specific type of protective equipment. With the invention, a RFID tag method and apparatus encoded with protective equipment information provides that specifically encoded near-field communications-enabled devices for specific protective equipment would present the user with a series of placards and acknowledgment screens for the worker to affirm he is wearing the correct protective equipment before entering the hazardous environment. With the invention, a RFID tag method and apparatus encoded with protective equipment information provides an interactive process either of verifying that the warning has been given or that the worker is acting in compliance with that warning. With the invention, a RFID tag method and apparatus encoded with protective equipment information is provided which is able to provide proof of compliance if documentation is needed.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by Letters Patent of the United States is as follows:

1. A method for encoding an RFID tag, comprising the steps of:
encoding a first set of the RFID tag bit positions with bits having a one-to-one correspondence with elements of a set of types of protective equipment,
encoding a second set of the RFID tag bit positions with bits having a one-to-one correspondence with elements of a set of types of hazardous environments.

2. The method of claim 1 comprising the further step of employing a computer software program operating on a NFC-enabled device to communicate the status of bit settings of the first set of bit positions and bit settings of the second set of bit positions read from the RFID tag to a person, such that the person becomes aware of the presence of appropriate protective equipment with respect to specific hazardous environments.

3. The method of claim 2 comprising the further steps of:
employing a computer software program operating on a NFC-enabled device for prompting the worker to take a picture or video of themselves using the built-in camera on the device,
storing the picture on the NFC-enabled device's memory card until it is downloaded at a later time, wherein a timestamp of the picture serves as proof that the employee was properly outfitted prior to entering a work area.

4. The method of claim 2 comprising the further step of employing a computer software program operating on a NFC-enabled device whereby the worker clicks a checkbox or provides a digital signature that certifies that they are wearing all prescribed protective equipment for the hazardous space they are about to enter.

5. The method of claim 1 wherein either the first bit positions or the second bit locations can be related to the serial number of the RFID tag device.

6. The method of claim 1 wherein either the first bit positions or the second bit positions can be related to a one-time-programmable memory address.

7. The method of claim 1 wherein the first RFID tag is replaced by a near-field communications-enabled device that can emulate an RFID tag.

8. The method of claim 1 wherein the first set of bit positions with bits having a one-to-one correspondence with elements of a set of types of protective equipment include bit positions for protective equipment including hard hat, ear protection, eye protection, reflective vest, steel toed boots, leather gloves, etc.

9. The method of claim 1 wherein the second set of bit positions having a one-to-one correspondence with elements of a set of types of hazardous environments include bit positions for hazardous environments including high voltage, no smoking, wet floor, electrostatic devices, inflammable, laser radiation, biological, chemical, nuclear, etc.

10. An RFID tag which includes a first set of bits having a one-to-one correspondence with elements of a set of types of protective equipment.

11. The method of claim 1 comprising the further steps of:
employing a computer software program operating on a NFC-enabled device for prompting the worker to touch an RFID tag embedded within each piece of protective equipment to assemble an inventory of protective equipment and RFID tag serial numbers being worn,
storing the inventory of protective equipment on the NFC-enabled device's memory card until it is downloaded at a later time, wherein a timestamp of the inventory and the RFID tag serial numbers serves as proof that the employee was properly outfitted prior to entering a work area.

12. The RFID tag apparatus of claim 10, further including:
a second set of bits having a one-to-one correspondence with elements of a set of types of hazardous environments.

13. The method of claim 1 wherein an area protected by an electronic lock cannot be opened until the worker certifies via the NFC-enabled device that they are wearing the requisite protective equipment required to access the hazardous space.

14. The method of claim 13 comprising the further step of employing a computer software program that counts the number of workers in the hazardous space.

15. The method of claim 13 comprising the further step of employing computer software program that verifies the worker has received any and all specialized training required to access the hazardous space.

16. The method of claim 13 comprising the further step of employing computer software program that tracks the duration of the worker's time within the hazardous space.
